(19) United States
(12) Patent Application Publication
(10) Pub. No.: US 2020/0151303 A1
(43) Pub. Date: May 14, 2020

(54) DIGITAL RIGHTS MANAGEMENT

(71) Applicant: International Business Machines Corporation, Armonk, NY (US)

(72) Inventors: Alan Chandler, Lawrenceville, GA (US); David Crick, Hoschton, GA (US); Pravin Mane, Cumming, GA (US); Brian H. McKendrick, Johns Island, SC (US); James D. Tanner, Decatur, GA (US)

(21) Appl. No.: 16/186,878

(22) Filed: Nov. 12, 2018

(51) Int. Cl. G06F 21/10; G06Q 50/18

(52) U.S. Cl. CPC G06F 21/105; G06F 2221/0771; G06Q 50/184

(57) ABSTRACT

Embodiments include method, systems and computer program products for digital rights management. Aspects include receiving, by a processor, a request to access media content from a requestor, wherein the media content is protected by a digital rights management (DRM) system that requires a license, obtaining context data associated with the requestor, analyzing the context data to determine a validity score for the request, and transmitting a license or access key to the requestor based on determining that the validity score exceeds a threshold.

### BACKGROUND

The present invention generally relates to digital rights management, and more specifically, to a digital rights management engine abstractions.

Digital rights management (DRM) is a technology for securing digital content. DRM works by encrypting content before distribution, and by limiting access to only those end-users who have acquired a proper license to play the content. Typically, the DRM license enforcement is done at the player/client. A complete DRM system typically comprises several parts: encryption, business-logic, and license-delivery. DRM starts by encrypting the content. Once the content is encrypted, a key is required to unlock (decrypt) the content. The encrypted content can be delivered to the end user through any appropriate delivery methods. Typically, an end-user who desires to obtain the content visits an e-commerce web site and transacts with the business-logic process, usually involving one of registration, login, and/or payment; once this is done, the end-user is issued a license to play the content. The issued license typically comprises (i) a key (for decrypting the content), (ii) a set of rights (e.g. play exactly once, play for 30 days, or the like), and (iii) with the property that the license is valid only on the end-user machine to which it is issued. When an end-user attempts to play the DRM-protected content, the player first checks to see whether the license exists on the local machine; if so, the playback starts by decrypting the content. If a license is not found, the player attempts to get a license, typically from the storefront URL that is embedded in the content.

### SUMMARY

Embodiments of the present invention are directed to a computer-implemented method for digital rights management. A non-limiting example of the computer-implemented method includes receiving, by a processor, a request to access media content from a requestor, wherein the media content is protected by a digital rights management (DRM) system that requires a license, obtaining context data associated with the requestor, analyzing the context data to determine a validity score for the request, and transmitting a license or access key to the requestor based on determining that the validity score exceeds a threshold.

Embodiments of the present invention are directed to a system for digital rights management. A non-limiting example of the system includes a processor coupled to a memory, the processor being configured to receive a request to access media content from a requestor, wherein the media content is protected by a digital rights management (DRM) system that requires a license, obtain context data associated with the requestor, analyze the context data to determine a validity score for the request, and transmit a license to the requestor based on determining that the validity score exceeds a threshold.

Embodiments of the invention are directed to a computer program product for digital rights management, the computer program product comprising a computer readable storage medium having program instructions embodied therewith. The program instructions are executable by a processor to cause the processor to perform a method. A non-limiting example of the method includes receiving, by a processor, a request to access media content from a requestor, wherein the media content is protected by a digital rights management (DRM) system that requires a license, obtaining context data associated with the requestor, analyzing the context data to determine a validity score for the request, and transmitting a license or access key to the requestor based on determining that the validity score exceeds a threshold.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in implementing one or more embodiments of the present invention;

FIG. 4 depicts a block diagram of a system for digital rights management according to one or more embodiments of the invention; and

FIG. 5 depicts a flow diagram of a method for digital rights management according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

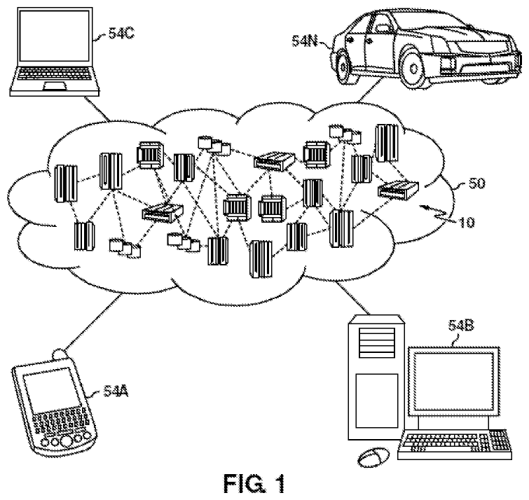

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

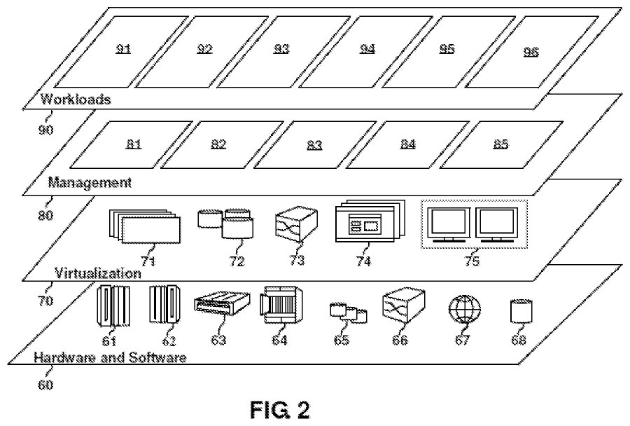

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and digital rights management 96.

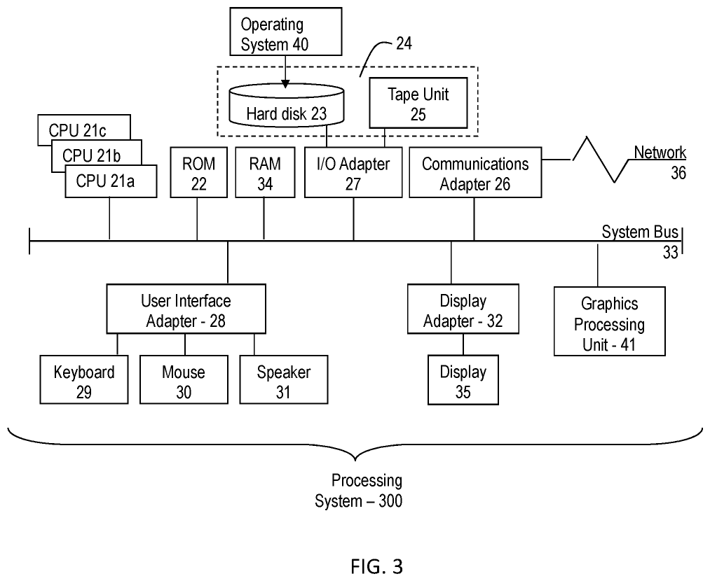

Referring to FIG. 3, there is shown an embodiment of a processing system 300 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 300.

FIG. 3 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 300 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 3, the system 300 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 3.

Turning now to an overview of technologies that are more specifically relevant to aspects of the invention, there are several widely utilized Digital Rights Management (DRM) protection services in the marketplace. For companies that utilize a multi-tenant, multi-device cloud video platform, a protection system must support protected playout of content regardless of which DRM system is employed by the user. Thus, a need exists for an abstraction layer for a unified interface that can provide a single, trusted, and secure source for encryption key management and license acquisition requests regardless of the type of DRM system employed.

Turning now to an overview of the aspects of the invention, one or more embodiments of the invention address the above-described shortcomings of the prior art by providing a process by which a media player can request a license for specified media content from different types of media devices regardless of the form of the DRM that is employed. The process includes a decision as to whether or not to grant a license delegated at the time of receipt of the request to access the specified content. The specified media content can include access to video data, audio data, and the like. The process implements an abstraction layer in the form of a license acquisition service that provisions decryption keys and/or licenses for media content or software that is protected by a digital rights management (DRM) system and requires a license.

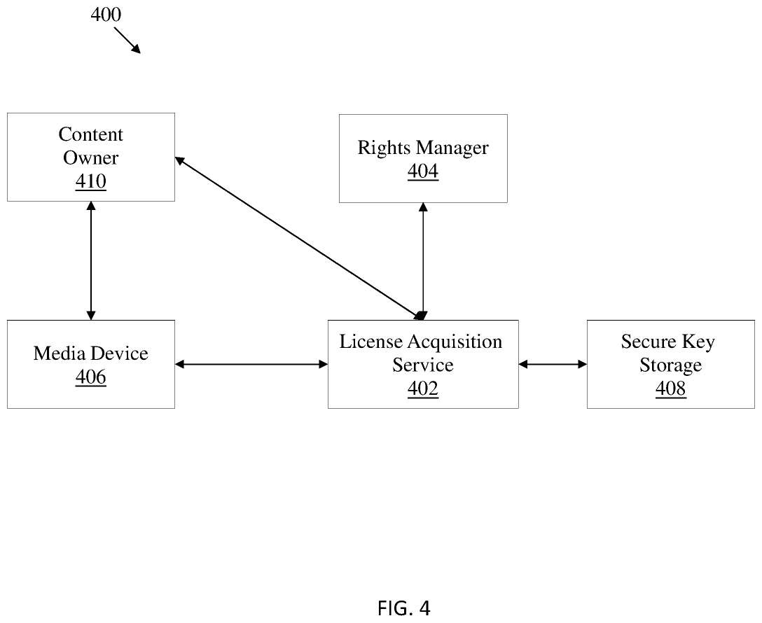

Turning now to a more detailed description of aspects of the present invention, FIG. 4 depicts a system for digital rights management according to embodiments of the invention. The system 400 includes a license acquisition service 402, a rights manager 404, and a secure key storage system 408.

In one or more embodiments of the invention, the license acquisition service 402, rights manager 404, and secure key storage system 408 can be implemented on the processing system 300 found in FIG. 3. Additionally, the cloud computing system 50 can be in wired or wireless electronic communication with one or all of the elements of the system 400. Cloud 50 can supplement, support or replace some or all of the functionality of the elements of the system 400. Additionally, some or all of the functionality of the elements of system 400 can be implemented as a node 10 (shown in FIGS. 1 and 2) of cloud 50. Cloud computing node 10 is only one example of a suitable cloud computing node and is not intended to suggest any limitation as to the scope of use or functionality of embodiments of the invention described herein.

In one or more embodiments of the invention, a media device 406 attempts to perform some action on protected content and determines that the content is encrypted, protected, or rights-limited in some way due to the presence of one or more forms of digital rights management. In this case, to perform the action on the content, the media device 406 requires a license and/or a decryption key. The content can be any type of digital content including audio files, video files, software, or any other binary content that is or can be subject to digital rights management. Based on the specific type of DRM employed by the content, the media device 406 attempts to obtain a license or decryption key through a pre-established or standard means that includes the media device 406 making a network request to the license acquisition service 402 using a license acquisition uniform resource locator (URL) provided to the media device 406 by a content owner 410 (or provider of the content). The content owner 410 can be an application on one or more servers housing the content being requested. This license acquisition URL directs the media device 406 to the license acquisition service 402 in a manner agnostic to the DRM system employed by the content owner 410. In embodiments of the invention, the license acquisition URL can be obtained by the media device 406 (e.g., the requestor or requesting application) by a variety of means include, but not limited to, being stored inside the content, stored inside a manifest associated with the content, read from a catalog associated with the content, or derived via algorithmic means based on one or more content attributes, such as, for example, a content identifier.

In one or more embodiments of the invention, the license acquisition service 402, after receipt of the license acquisition URL (e.g., request), obtains context information associated with the media device 406 (e.g., requestor) to determine the identity of the content for which a license or decryption key is requested. Also, additional context data can be collected or generated by the license acquisition service 402 from sources including, but not limited to, the requestor's network IP address, geolocation data collected from a GPS application on the media device 406, media device type, identity of the user of the media device 406, web, cookies, and/or header information associated with the request. This context data collected from the requestor (e.g., media device 406) or generated from other sources (e.g., IP address) is provided to the rights manager 404 via an application program interface (API). The rights manager 404 analyzes the context data to calculate a validity score representative of the likelihood that the media device 406 should have access to the content being requested. To determine whether the media device 406 should or should not have access to the content, the rights manager 404 can compare the validity score calculated from the context data to a predefined threshold score or value. If the validity score exceeds the threshold, the rights manager 404 indicates the media device 406 should have access to the content and the license acquisition service 402 can obtain the license or decryption key from the secure key storage system 408 and transmit the license or decryption key to the media device 406. If the validity score does not exceed the threshold, the rights manager 404 can send a denial to the license acquisition service 402. The license acquisition service 402 can transmit the denial to the media device 406 or transmit a request for additional data to verify the media device 406 should have access to the content. The rights manager 404 performs the analysis of the context data without knowing the type of DRM system used to protect the content.

In one or more embodiments of the invention, the validity score is calculated based on the context data associated with the request for access to content. For example, request for a specific content can be received by the license acquisition service 402. The context data can include the identification of the requestor, the identification of the requestor's account, and the identification of the requested content. Additional context data can be generated from information taken from the media device (e.g., the device is a smartphone, geo-location, etc.). Analyzing the context data can determine the validity score, and thus whether the requestor is entitled to access the requested content, and furthermore whether or not a particular license or decryption key should be returned to the requestor. In one or more embodiments of the invention, the license acquisition service 402 collects context data from both the requestor and from the content owner 410. The rights manager 404, for example, can provide information about the requestor's account status and payment information to be utilized when determining if the requestor is allowed access to the content. For example, a media device 406 might have access to specific content but only in certain formats. A request to play a movie using 4K technology might not be available based on the requestor's subscription information; however, the same movie might be available in a lower quality format. The rights manager 404 can determine the specific type of license or decryption key to be provided for the media device 406 so that the correct format or version of the content can be accessed by the media device 406. For example, the rights manager 404 can restrict access due to there being no current login session in place. The rights manager 404 can restrict access based on the requestor having too many simultaneous sessions open or there is a geographic restriction on where content can be accessed.

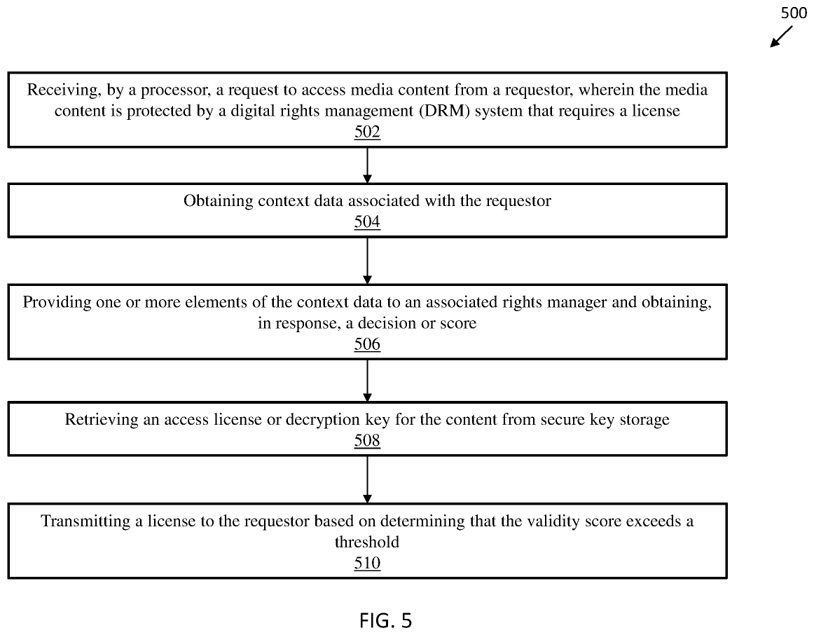

FIG. 5 depicts a flow diagram of a method for digital rights management according to one or more embodiments of the invention. The method 500 includes receiving, by a processor, a request to access media content from a requestor, wherein the media content is protected by a digital rights management (DRM) system that requires a license, as shown in block 502. At block 504, the method 500 then obtains context data associated with the requestor. The method 500, then, provides one or more elements of the context data to an associated rights manager and obtaining, in response, a decision or score, as shown at block 506. At block 508, the method 500 includes retrieving an access license or decryption key for the content from secure key storage. And at block 510, the method 500 includes transmitting a license to the requestor based on determining that the validity score exceeds a threshold.

Additional processes may also be included. It should be understood that the processes depicted in FIG. 5 represent illustrations, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for media rights management, the method comprising:
receiving, by a processor, a request to access media content from a requestor, wherein the media content is protected by a digital rights management (DRM) system that requires a license;
obtaining context data associated with the requestor;
analyzing the context data to determine a validity score for the request; and
transmitting a license or access key to the requestor based on determining that the validity score exceeds a threshold.

2. The computer implemented method of claim 1 further comprising transmitting a denial to the requested based on determining that the validity score does not exceed the threshold.

3. The computer implemented method of claim 1, wherein the context data comprises at least one of a global positioning system (GPS) location, an internet protocol (IP) address of the requestor, a device type of the requestor, a unique device identifier, a timestamp request, and requestor device capabilities data.

4. The computer implemented method of claim 1, wherein the context data is obtained from an application associated with the requestor.

5. The computer implemented method of claim 1, wherein the context data is obtained from a server application associated with the requestor.

6. The computer implemented method of claim 1, wherein the license is accessed from a secure key storage.

7. The computer implemented method of claim 1, wherein obtaining context data associated with the requestor comprises:
receiving a license request via a license acquisition uniform resource locator (URL) obtained by the requestor; and
retrieving, from the requestor, the context data via the license acquisition URL.

8. A system for digital rights management, the system comprising:
a processor coupled to a memory, the processor being configured to:
receive a request to access media content from a requestor, wherein the media content is protected by a digital rights management (DRM) system that requires a license;
obtain context data associated with the requestor;
analyze the context data to determine a validity score for the request; and
transmit a license or access key to the requestor based on determining that the validity score exceeds a threshold.

9. The system of claim 8, wherein the processor is further configured to transmit a denial to the requested based on determining that the validity score does not exceed the threshold.

10. The system of claim 8, wherein the context data comprises at least one of a global positioning system (GPS) location, an internet protocol (IP) address of the requestor, a device type of the requestor, a unique device identifier, a timestamp request, and requestor device capabilities data.

11. The system of claim 8, wherein the context data is obtained from an application associated with the requestor.

12. The system of claim 8, wherein the context data is obtained from a server application associated with the requestor.

13. The system of claim 8, wherein the license is accessed from a secure key storage.

14. The system of claim 8, wherein obtaining context data associated with the requestor comprises:
receiving a license request via a license acquisition uniform resource locator (URL) obtained by the requestor; and
retrieving, from the requestor, the context data via the license acquisition URL.

15. A computer program product for digital rights management, the computer program product comprising a computer readable storage medium having program instructions embodied therewith, wherein the computer readable storage medium is not a transitory signal per se, the program instructions executable by a processor to cause the processor to perform a method comprising:
receiving, by the processor, a request to access media content from a requestor, wherein the media content is protected by a digital rights management (DRM) system that requires a license;
obtaining context data associated with the requestor;
analyzing the context data to determine a validity score for the request; and
transmitting a license or access key to the requestor based on determining that the validity score exceeds a threshold.

16. The computer program product of claim 15 further comprising transmitting a denial to the requested based on determining that the validity score does not exceed the threshold.

17. The computer program product of claim 15, wherein the context data comprises at least one of a global positioning system (GPS) location, an internet protocol (IP) address of the requestor, a device type of the requestor, a unique device identifier, a timestamp request, and requestor device capabilities data.

18. The computer program product of claim 15, wherein the context data is obtained from an application associated with the requestor.

19. The computer program product of claim 15, wherein the license is accessed from a secure key storage.

20. The computer program product of claim 15, wherein obtaining context data associated with the requestor comprises:
receiving a license request via a license acquisition uniform resource locator (URL) obtained by the requestor; and
obtaining context data associated with the license request from data provided by the requestor or from attributes of the request.
